(19) United States
(12) Patent Application Publication
(10) Pub. No.: US 2023/0074078 A1
(43) Pub. Date: Mar. 9, 2023

(54) IRRIGATION SPRINKLER

(71) Applicant: Ori BRAUN, Palo Alto, CA (US)

(72) Inventor: Ori BRAUN, Palo Alto, CA (US)

(21) Appl. No.: 17/768,939

(22) PCT Filed: Aug. 6, 2020
(86) PCT No.: PCT/IB2020/057453

§ 371 Date: Apr. 14, 2022

Related U.S. Application Data
(60) Provisional application No. 62/923,833, filed on Oct. 21, 2019.

(51) Int. Cl. B05B 1/16; B05B 1/30; B05B 1/32; B05B 3/02

(52) U.S. Cl. CPC B05B 1/1672; B05B 1/3026; B05B 1/326; B05B 3/02; B05B 15/652

(57) ABSTRACT

A sprinkler head for attaching to a stem of a sprinkler, the sprinkler head having a round or polygonal shaped perimeter and comprising a directional nozzle array on the perimeter of the sprinkler head, the directional nozzle array comprises a single nozzle or a stack of nozzles each nozzle having an orifice facing a specific radial direction; the directional nozzle array being in fluid connection with a conduit through the stem for providing irrigation in the radial direction; wherein the directional nozzle array is provided with a dedicated regulator independently configurable by the user for regulating water flow in the specific radial direction over a range from zero when fully closed to a maximum range when fully open.

### BACKGROUND

In regions with unreliable rainfall, irrigation is used in agriculture and horticulture, for irrigating crops, lawns, football pitches, and the like. However, with water being a resource that requires conserving, there is a need to minimize wastage.

One commonly employed irrigation technique is to use commercially available sprinklers.

There are two basic types of sprinkler heads. The first is a simple, above ground set up, where the head fits onto a hose pipe. This requires the owner to stand out in the yard and spray water with a hose for hours each week. Alternatively, a sprinkler that can be put on the ground may be used, and the user then moves the sprinkler around the property and make sure that all areas are irrigated.

A second option is to install an in-ground system. Each in-ground sprinkler system has a main line which leads to different branches. A sprinkler unit is positioned at the end of each branch. The sprinkler unit is designed to spray water over a designated area. The sprinkler unit either protrudes above the ground, or is designed to ‘pop up’, meaning that it is buried in the ground, and when activated, the water pressure causes an upper section to pop up above the ground level, to sprinkle water, and then to retract to ground level after use, enabling the lawn, golf course or other planted area to be subsequently mowed, and removing an obstruction that could trip up children, etc.

The shape of each nozzle and the configuration of nozzles on the sprinkler head is shaped according to what kind of spray pattern the nozzles are designed to deliver, and how many streams of water the sprinkler head can pump out at once.

Each sprinkler head is designed to create flows of water that shoot out of the individual nozzles of the head and onto the surrounding area. There are three basic types of spray patterns: fixed, rotating, and mist.

The sprinkler with the fixed spray pattern is designed to stay stationary. Most commonly, it consists of multiple thin streams of water that fan out from nozzles arranged around the center of a circular head. Usually, the water that is pumped out can reach about 3 to 15 feet.

Although some fixed spray sprinkler heads have non-adjustable nozzle configurations, and spray in 360°, or in 180°, 90°, etc., other sprinkler heads can be adjusted to irrigate in a targeted direction over a range, of say from 40° degrees to a full 360°.

Thus a fixed 180° sprinkler head, or a sprinkler head adjusted to spray water over a 180° arc may be used alongside a paved pathway, thereby watering the grass but not the paved area.

Pop up sprinklers typically protrude about 2 inches above the ground when in use, and sink back to ground level when the water pressure is switched off. Where it is necessary to clear rough grass, sprinklers that pop up 4 inches are used. Some are even designed to pop up to heights of 20° inches for irrigating flowering plants and the like.

Another type of sprinkler is the rotating head type sprinkler which throws water over a larger range, and is typically used to irrigate plants that are 20 to 150 feet away from the sprinkler. Gear-driven rotating heads are designed to turn anywhere from 40° to 360° degrees, and typically irrigate an area having a radius of 18 to 55 feet. This makes them well suited to irrigating large yards or industrial and commercial areas. The impact rotating sprinkler has a directed jet that is moved around its path by an impacter. These systems are most often used in public areas, such as parks, play areas, sports fields and the like. These usually require regular maintenance, because they have finely tuned moving parts that are subject to wear, and can malfunction over time.

There are also large turf rotors that are used for irrigating areas such as golf courses, where a significant amount of mowed grass needs watering. Each turf rotor may irrigate an area therearound to a radius of 100 feet.

### SUMMARY OF THE INVENTION

There is an advantage to provide irrigation where needed, such as to lawns, and to ensure that all parts of the lawn that need to be irrigated are properly irrigated, preventing the grass from yellowing, whilst also avoiding the unnecessary irrigating of adjacent land that is not planted, such as paths, fences, driveways and the like.

Lawns may be rectangular or oval rather than circular, and even along an arc. Therefore, in some cases it is necessary to sprinkle over a longer distance in one part of the arc for example the middle of the arc, and over shorter distances at one or both ends, or to sprinkle over longer distances at each end and shorter distances in the middle.

Certain embodiments provide sprinklers that can be better tailored to irrigate non-standard areas requiring irrigation, such as lawns, whilst ensuring irrigation of the entire area up to the edges, whilst avoiding irrigating adjacent areas such as pathways.

In certain embodiments, the sprinkler head can be set to sprinkle in two or three discontinuous directions, over arcs of different lengths, and in some cases over different ranges in each direction.

Some embodiments provide a sprinkler head that can provide water at a desired lateral angle around the sprinkler head, up to all directions (360°), or in a smaller angle, or to a range of smaller angles in desired directions, and which can be set to sprinkle over a range of distances from not sprinkling at all, to sprinkling over a maximum range in each direction.

The term nozzle array as used herein, refers to a nozzle or a stack of nozzles on a sprinkler head that directs water outwards in a specific radial direction.

The term orifice as used herein refers to an outlet of a nozzle.

A radial direction may be provided with a single nozzle or by a stack of nozzles in the same general radial direction, wherein each nozzle is directed to a different range.

Certain embodiments deliver a fairly constant amount of water per unit area per unit time, no matter the range, which is an advantage. Since the area covered increases with the square of the range, to obtain a constant irrigation rate at all distances, more water is required to be sent to more distance areas. This may be achieved by each general radial direction being provided with either a single nozzle that is shaped to provide more water at maximum trajectories or by a stack of nozzles, having larger nozzles directed to further ranges. Thus in some embodiments, a shaped nozzle or stack of nozzles is shaped to spray less water over an area close to the sprinkler and increasing amounts of water with increased distance, to the maximum range, which in certain embodiments, is user configurable, but to deliver a fairly constant amount of water per unit area, independent of distance.

An embodiment is directed to providing a sprinkler head for attaching to a stem of a sprinkler, the sprinkler head for closing the stem, said sprinkler head having a round or polygonal shaped perimeter and comprising at least one directional nozzle array on the perimeter of the sprinkler head facing a radial direction for providing irrigation in the radial direction; the at least one directional nozzle array being provided with a dedicated regulator for regulating water flow therethrough over a range from fully open to fully closed.

In certain embodiments, each directional nozzle array comprises a single nozzle or a stack of nozzles for irrigating in a specific direction.

Typically, the regulator of each nozzle array may be independently configured by the user to determine the range in each direction, and its position remains fixed until reconfigured.

Typically, the sprinkler head is provided with a plurality of nozzle arrays along a section of the perimeter of the sprinkler head; each nozzle array having a dedicated regulator.

In certain embodiments, a plurality of nozzle arrays is provided around the entire perimeter of the sprinkler head, each nozzle array having a dedicated regulator.

In some embodiments, the regulator of each nozzle array simultaneously adjusts both the angle of elevation of the nozzle array and the throughput thereof.

Typically, each nozzle or stack of nozzles in a nozzle array faces the same general radial direction, but is configured to sprinkle water over a different range.

Optionally, the dedicated regulator further regulates a range of spraying distances from between zero and maximum range. In some embodiments, each nozzle passes through a wall of the sprinkler head and ends at an orifice on the outer perimeter.

Optionally, each nozzle is angled to direct water sprayed through its orifice to appropriate desired distance from the sprinkler head.

In some embodiments, each radial direction is provided with a single nozzle having an inverted triangular orifice with a wide top, narrowing downwards to a tip, and the regulator is a sliding valve that is positionable to block at least part of the orifice, by being slid downwards from the top towards the tip to progressively block the orifice and minimize through flow and range of spray therethrough, thereby shrinking the effective opening of the orifice to regulate the range of water sprayed therethrough from fully open to fully closed.

In some embodiments, side walls of the triangle are selected from the group comprising straight lines, convex curves and concave curves.

In some embodiments each radial direction is served by a stack of nozzles through a wall of the sprinkler head each nozzle ending in an orifice on the perimeter of the sprinkler head, and each nozzle being is angled to direct water sprayed therethrough to a different desired distance from the sprinkler head.

In some embodiments, each radial direction is provided with a generally inverted triangular shaped stack of nozzles passing through a wall of the sprinkler head, and the regulator is a sliding rod that is positionable to block none, some or all of the nozzles by being slid along a socket within a wall of the sprinkler head that traverses the nozzles, thereby partially or fully blocking at least one nozzle of the stack of nozzles to regulate the range of water sprayed therethrough from zero distance when the stack of nozzles is fully blocked, to a maximum distance when the stack of nozzles fully opened.

Optionally, each nozzle comprises a circular orifice.

Optionally, each orifice is an end of a nozzle through a wall of the sprinkler head that is angled to the horizontal to direct water sprayed therethrough to a different distance from the sprinkler head.

In some embodiments, each nozzle is provided with a regulator comprising a ball that rests in a snug fitting socket, and an adjustment lever coupled to the ball; the ball of the ball and socket valve comprising a passage from an inlet that is partially alignable, fully alignable and misalignable with a conduit in the sprinkler head that is coupled to the water supply, to a nozzle ending at an orifice on the perimeter of the ball facing generally outwards from the perimeter of the sprinkler head, such that the adjustment lever can be moved along the slot, thereby adjusting the ball in socket valve from fully closed to fully opened, for simultaneously adjusting the quantity of water sprayed through the nozzle from zero to a maximum and for adjusting the trajectory of the water sprayed to a maximum range.

In some embodiments, the nozzle is configured to provide a near constant irrigation density with distance from the sprinkler head over a range.

In some embodiments, the position and orientation of the nozzle of the regulator can be adjusted by a screw driver engaging a notch for a screw driver provided at an end of the lever.

In some embodiments, the angle of elevation of the nozzle and/or sideways tilt are adjustable.

The sprinkler head may be provided with an attachment component or attachment mechanism configured for attaching to the stem of a fixed or pop-up sprinkler unit.

The sprinkler head may however be integral to a sprinkler unit and a head that is retrofittable to a stem of a sprinkler unit for converting a prior art sprinkler to a sprinkler.

### BRIEF DESCRIPTION OF THE FIGURES

For a better understanding of the invention and to show how it may be carried into effect, reference will now be made, purely by way of example, to the accompanying Figures, wherewith it is stressed that the particulars shown are by way of example and for purposes of illustrative discussion of the embodiments of the invention only, and are presented in the cause of providing what is believed to be the most useful and readily understood description of the principles and conceptual aspects of the invention.

In the drawings, like components are generally designated by like reference numerals, wherein:

FIG. 1 is schematic annotated side view of a pop up sprinkler installed in the ground;

FIG. 2 is schematic annotated side view of the pop up sprinkler of FIG. 1 in its pop-up configuration whilst sprinkling;

FIG. 3 is a schematic bird's eye view of a sprinkler configured to provide 360° coverage therearound;

FIG. 4 is a schematic bird's eye view of a sprinkler configured to provide 90° coverage;

FIG. 5 is a schematic bird's eye view showing how two sprinklers, each configured to provide 90° coverage that are installed in opposite corners of a square lawn can irrigate the entire lawn;

FIG. 6 is a schematic bird's eye view showing two quarter segments of lawn separated by quarter segments of pavement, as an example of a lawn that cannot be irrigated with a single pop-up sprinkler efficiently;

FIG. 7 is a schematic bird's eye view of an elliptically shaped lawn being watered from a central sprinkler to a range of the shorter diameter of the lawn, such that the ground towards the ends of the longer diameter are not watered;

FIG. 8 is a schematic bird's eye view of an elliptically shaped lawn being watered from a central sprinkler to a range of the longer diameter of the lawn, such that a lot of surrounding ground beyond the ends of the shorter diameter are unnecessarily watered;

FIG. 9 is a cross section through the head of a sprinkler, with regulators removed, showing the shape of the nozzle, in accordance with one embodiment;

FIG. 10 is a perspective view of the head of a sprinkler of FIG. 9, in accordance with one embodiment;

FIGS. 11 and 12 show the sprinkler head of FIGS. 9 and 10 with sliding valve type regulators in front of each nozzle for regulating the amount of water allowed to pass therethrough, from zero to a maximum, in accordance with one embodiment;

FIG. 13 is a front view of a single nozzle of the type in FIGS. 9-12, with a vertical track along on each side, in accordance with one embodiment;

FIG. 14 shows the nozzle of FIG. 13 from the front, with a sliding regulator or stopper mounted on the vertical tracks, for slidably regulating the amount of water allowed through the orifice, in accordance with one embodiment;

FIG. 15 is a top view of the nozzle and sliding regulator of FIG. 14, in accordance with one embodiment;

FIG. 16 and FIG. 17 are schematic side views and perspective views of a further embodiment, where each radial direction is provided with a nozzle array having a vertical stack of nozzles, each having a circular orifice of different diameter and where the regulator is a rod within a vertical socket behind the orifices, such that lowering the rod within its socket partially or fully blocks one or more nozzles, in accordance with one embodiment;

FIG. 18 is a schematic isometric projection of a sprinkler head, generally in accordance with the embodiment of FIGS. 16 and 17, but designed for ease of configuration, where rods can be slid downwards in their sockets to block the one or more nozzles of a stack of nozzles, the rods being manipulated by a peg coupled to the rod, that may be slid down a notched slot so that the rod can block one or more nozzles of the stack, thereby reducing the range sprayed in the radial direction to which the stack points, in accordance with one embodiment;

FIG. 19 is an isometric projection of a sprinkler head with a plurality of ball-in-socket type regulators each having a nozzle within the ball opening in an orifice on the surface of the ball for spraying water therethrough, the nozzle coupled to an inlet on the base of the ball that is selectively alignable with a conduit though the body of the sprinkler head, and each regulator being provided with an external lever for adjusting the position of the inlet with respect to the conduit, and the position and orientation of the orifice of the nozzle, in accordance with one embodiment;

FIG. 20 is a detail of a single ball in socket regulator showing the lever and nozzle in more detail, the lever moved to an angle such that the inlet is no longer aligned with the conduit through the body of the sprinkler head, and thus the nozzle is disconnected from the water supply, where sealing between the ball of the ball regulator and the base of the sprinkler head around the conduit is provided by an o-ring, in accordance with one embodiment;

FIG. 21 is an exploded view of the sprinkler head of FIG. 19, with the regulators in the open position, such that their levers point upwards, and the inlet (not shown) of each ball in socket regulator is aligned with the conduit (not shown) in an open position, allowing water from the water main to reach the nozzles, wherein a gasket with sockets for the ball valves is provided, that replaces the individual o-rings, each socket having an aperture therethrough for enabling fluid contact between the inlet of the ball valve and the conduit through the base of the sprinkler head, in accordance with one embodiment;

FIG. 22 is a further exploding view, also showing the screw that holds the lid of the sprinkler head to the body thereof, for tightly holding the balls valves of the regulators against the gasket, in accordance with one embodiment;

FIG. 23 is an example of an irregularly shaped lawn that can be efficiently and effectively irrigated by a sprinkler with the sprinkler head of an embodiment of the invention, since the range in each direction can be individually controlled, in accordance with one embodiment, and

FIG. 24 shows a rectangular area being irrigated by a single sprinkler, in accordance with one embodiment.

### DESCRIPTION OF EMBODIMENTS

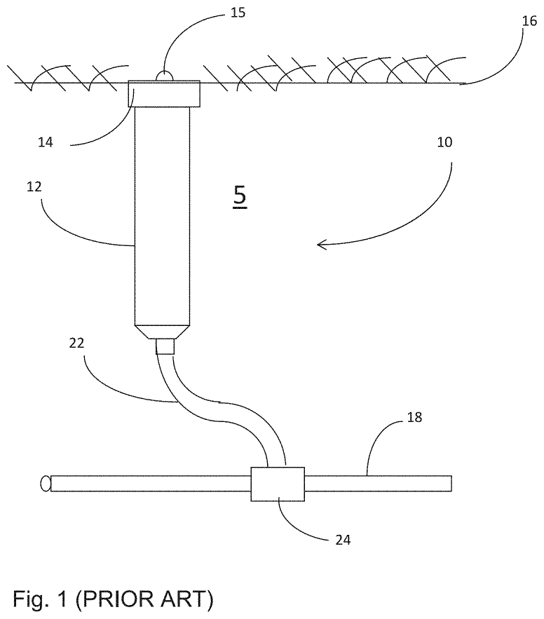

With reference to FIG. 1, a prior art pop up sprinkler is shown. The body 12 of a pop up sprinkler 10 installed underground 5, so that the cap 14 thereof is at soil level 16. There is usually a screw 15 in the center of the cap 14 that can be opened to dismantle the sprinkler 10. Sometimes the screw serves as a regulator for the sprinkler, controlling its range.

The pop up sprinkler 10 is coupled to an underground PVC lateral water pipe 18 by a swing pipe 22 that is coupled to the inlet of the body 12, perhaps by an elbow connector, and is also coupled to a T or L junction 24 of the lateral pipe 18.

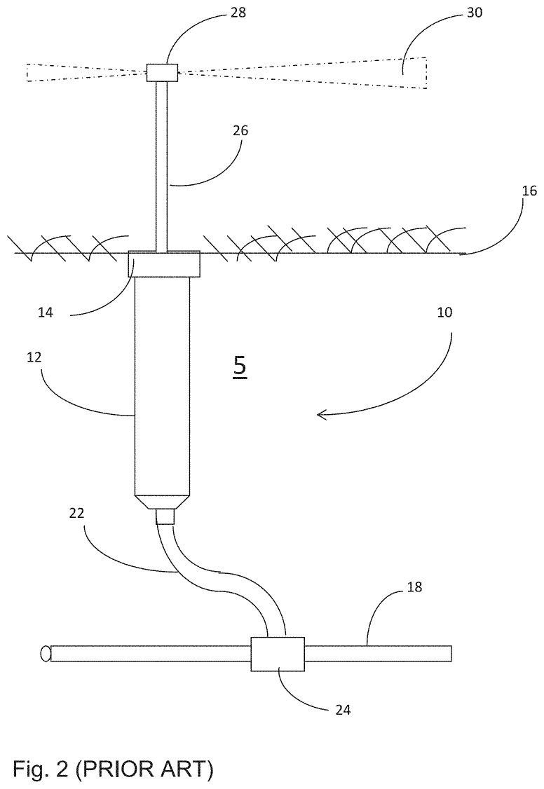

Referring to FIG. 2, when activated by opening a mains valve (not shown) to increase the water pressure in the lateral pipe 18, a riser 26 ascends (pops up) from the sprinkler body 12, driven by the water pressure which overcomes a helical retraction spring (not shown) with the body 12 that retracts the riser 26 back into the body when the water pressure drops as the valve (not shown) is closed. Attached to the top end of the riser 26 there is a sprinkler head 28 that has an array of nozzles therearound for sprinkling water jets 30 onto the surrounding area.

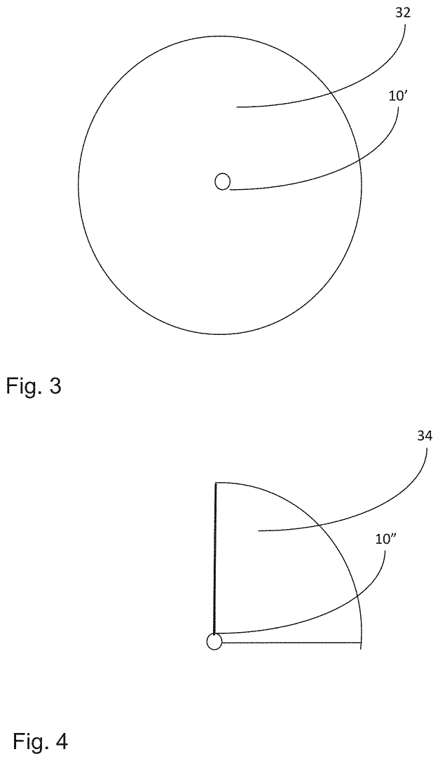

There are a large number of pop up sprinklers on the market. As shown in FIG. 3, a sprinkler 10′ may be configured to spray a full 360° to irrigate a circular area 32. Such a sprinkler 10′ is intended to be installed on a lawn, golf course or field. With reference to FIG. 4, another sprinkler 10″ may be designed to spray over a smaller angle of disbursement, such as a 90°, thereby irrigating a segment that is a quarter circle 34. Such a sprinkler 10″ is intended for installation in the corner of a lawn. Other sprinklers (not shown) may spray over a 180° angle of disbursement, and are intended to be installed along an edge of a lawn or other area to be irrigated.

Also known, are sprinklers that are radially adjustable such that the angle of the segment over which water is sprayed may be adjusted, to spray along an arc whose length can be set when installing the sprinkler or afterwards by the user. Some sprinklers can be set to spray over a range of segments from a small arc, such as 10°, to spraying in a full circle of 360°. Other sprinklers may only be adjusted over a smaller range, such as between 40° and 90°, for example. Typically, the adjustable sprinkler is configured such that the position of the extreme ends of the arc may be set to define the segment over which water is sprinkled.

In general, each radial direction may be served by a nozzle array that may be a single nozzle or a stack of nozzles each having an orifice on the perimeter the sprinkler head that faces in the same general radial direction., The array of nozzles is configured to provide similar quantities of water per unit area up to the maximum range of the sprinkler, regardless of distance from the sprinkler head. The maximum range of a sprinkler is determined by its design and by the water pressure. As stated hereinabove with reference to FIG. 1, sometimes a screw 15 on the sprinkler head 14 may be adjusted to reduce the range of the sprinkler 10, and such a screw simultaneously regulates the range of all nozzle arrays pointing in all directions, or at least over the entire segment sprayed by the sprinkler. Typically, a garden sprinkler has a maximum range of the order of 10 to 20 feet.

In general, the area served by each sprinkler increases with the square of the range. Similarly, the area served by each nozzle array on the perimeter of the sprinkler head, whether a single nozzle or a stack of nozzles, increases with the square of the distance from the sprinkler head. The nozzle or stack of nozzles in each nozzle array is generally configured to provide equal quantities of water per area to the ground at all distances over the range. As shown in FIG. 5, a pair of 90° sprinklers 10″ may be installed in opposite corners of a square lawn 36 to irrigate a square area.

However, despite their flexibility and wide usage, sprinklers as known, do not provide a full solution for all shapes of lawn. For example, in FIG. 6, a lawn 38 is shown having the shape of two quarter circles. A sprinkler placed in the center will adequately irrigate the lawn, but will also irrigate the two quarters where there is no lawn, which may be tarmac or concrete, and so 50% of the water sprayed may land on ground that is not planted, and will simply evaporate. Alternatively, one or other of the quarter circle segments may be irrigated by a 90° sprinkler, or a sprinkler that is configurable to spray over 90°. What is not possible with prior art sprinklers, however, is to only sprinkle over two or more separate and distinct segments.

U.S. Pat. No. 5,630,549 to Le describes a ‘solution’ to this type of problem, proposing a stack of sprinklers to provide a custom watering pattern. However, a stack of this kind cannot retract into the ground, and a permanently mounted above ground sprinkler stack is an obstruction that could be dangerous to children.

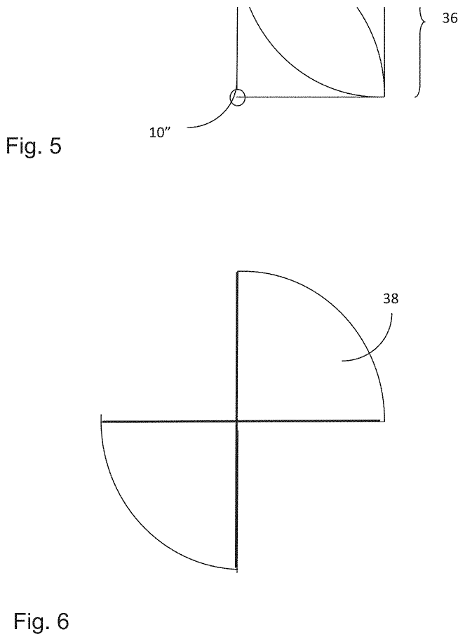

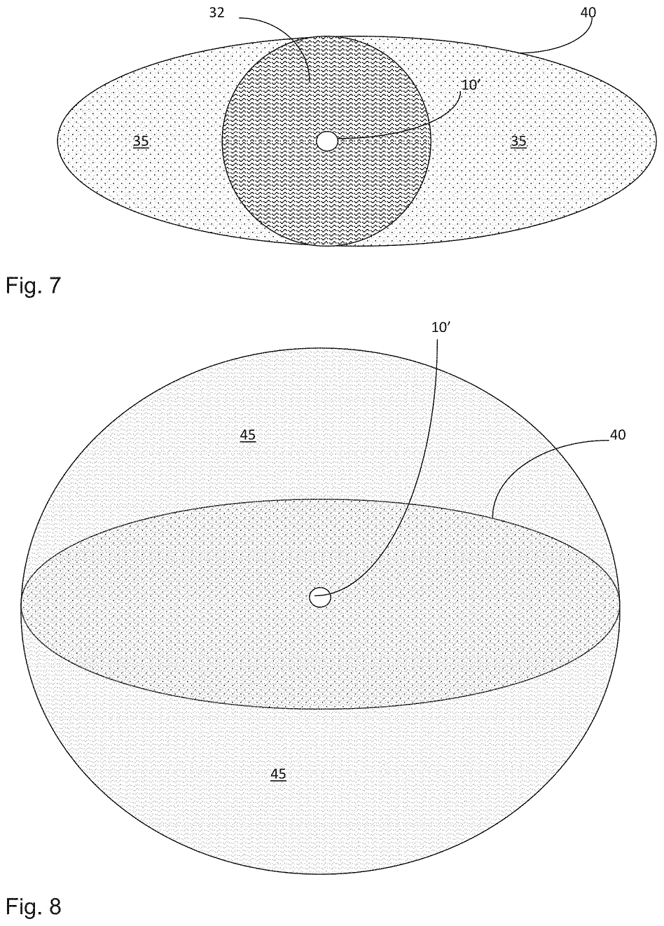

With reference to FIG. 7, it will be appreciated that a sprinkler 10′ placed in the middle of an elliptical lawn 40, could have a range of the small radius in which case a circular area 32 will get irrigated, but the ends of the lawn 35 will not get irrigated and the grass will yellow.

With reference to FIG. 8, a sprinkler 10′ having the range of the large radius of the lawn 40 will irrigate the lawn, but also a massive surrounding area 45, which could be paved over, and thus the water sprayed thereon would be wasted.

These examples are extreme. Nevertheless, it will be appreciated that prior art sprinklers often leave dry some peripheral areas of a lawn or other area to be irrigated, resulting in plants yellowing, and dying, whilst irrigating surrounding areas, such as pavements, driveways, decks and so on, where the water is wasted.

Embodiments of the invention described herein below address these deficiencies of sprinklers of the prior art, and provide greater control, for better conforming the area actually irrigated with that intended to be irrigated. Thus lawn sprinklers of the invention can be configured to irrigate an entire lawn, but not surrounding areas, regardless of the shape of the lawn, which may be elliptical or irregular.

Embodiments of the invention are directed to sprinkler heads for both fixed and pop up sprinklers that are provided with one or more nozzle arrays, each nozzle array pointing in a different radial direction, and the range of each nozzle array being separately configurable to enable the distance sprayed in each radial direction to be controlled over a range between no water being emitted, up to the maximum range of the sprinkler head, which in some embodiments may itself be configured, such as with an adjustment screw as known. The sprinkler heads described may be retrofitted to previously installed sprinkler units of a sprinkler system, replacing the prior art sprinkler heads, and may be provided with attachment means, such as an attachment component or mechanism, for example an appropriate screw threading, or with clips of various types. Alternatively, sprinkler heads of the invention may be provided as integral parts of sprinkler units, whether pop up of fixed.

Various designs for the body 12 of sprinkler units and for the risers 26 of pop up sprinklers 10 are known, and apart from the novel sprinkler heads described hereinbelow, the rest of the sprinkler unit may accord to any of the models commercially available or described in one of the many patent publications for lawn sprinklers. Sprinkler heads of the invention may be manufactured and sold as parts of fixed or pop-up sprinkler units or as replacement parts for sprinkler units that may be retrofitted in place of prior art sprinkler heads 26 of both the fixed and pop-up varieties.

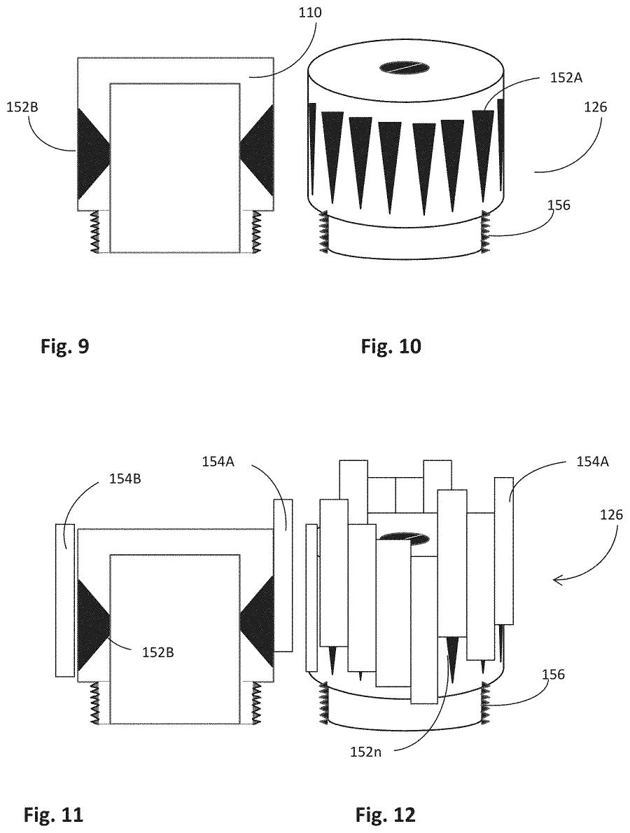

With reference to FIG. 9 and FIG. 10, in accordance with one embodiment, cross-sectional and isometric perspective views of a sprinkler head 126 are schematically shown, where the regulators thereof have been removed to fully show the shape of the nozzles, i.e. orifices 152A, 152B. Directional nozzles are arranged on the perimeter of the sprinkler head 126 facing radially outwards. Although a sprinkler head may have one single directional nozzle, more typically sprinkler heads with this type of nozzle are provided with a row of nozzles along at least part of their perimeter. Thus the sprinkler head 126 is provided with a plurality of nozzles 152A, 152B . . . 152n which with reference to FIGS. 11 and 12, is each provided with a dedicated regulator 154A, 154B for controlling the range in each sprayed direction. The nozzles are typically arranged with radial symmetry around the perimeter of the sprinkler head which may be substantially cylindrical or polygonal.

Optionally, an arc of the perimeter is not provided with nozzles. Thus, for example, where nozzles are only provided along half of the perimeter, the sprinkler head could be used for irrigating a lawn from a straight edge thereof, with a regulator 154n provided for each nozzle 152n for controlling the range in each sprayed direction. However, in this and in other embodiments illustrated herein, nozzles 152n are provided around the entire perimeter of the sprinkler head, and the individual regulators 154n can selectively partially or fully close each nozzle as desired, providing maximum flexibility.

In general, it will be appreciated that the number of nozzles that may be provided in a row around the circumference of the sprinkler head is a function of the size of the nozzle, its regulator and the diameter of the sprinkler head, and although typical embodiments provide 8-20 nozzles typically arranged equidistantly around their perimeter for irrigating in 8 to 20 regulated sprinkler directions, the number of nozzles in some embodiments will be smaller or larger, depending on the desired directional control, the size of the sprinkler head, and so on.

In the embodiments of FIGS. 9 to 12, each nozzle 152n has an inverted triangular orifice 152.

The sprinkler head 126 is provided with an attachment means 156 for attaching to the vertical stem of the sprinkler, which is typically a riser 26 of a pop-up sprinkler unit 10. In the embodiments of FIGS. 9 and 10, the attachment means 156 is a male screw thread, for engaging a corresponding female screw thread in the sprinkler stem. It will, however, be appreciated that the screw thread of the sprinkler head in other embodiments of the invention could be a female screw thread for attachment to a male screw thread on the sprinkler stem. Other attachment means such as clips or bayonet mechanisms could be provided. Indeed, in some embodiments, the sprinkler head could be integral to the sprinkler riser or the head and stem could be a single unit.

FIG. 9 is a cross section through the head of a sprinkler 150 in accordance with one embodiment of the invention and FIG. 10 is an isomeric projection of the sprinkler head 126, the regulators have been removed for clarity.

In this embodiment, each nozzle 152A, 152B ends in a single orifice that has the shape of an inverted isosceles triangle (see 152A of FIG. 10). As shown in FIG. 9 with reference to nozzle 152B, each nozzle generally fans out from within the sprinkler head to the orifice on the surface of the sprinkler head, and thus directs the water sprayed therethrough along an arc. The wider upper end of the orifice allows more water to pass through than the lower narrower end, and is generally configured to spray water further, to the maximum range of the sprinkler 126. A nozzle 152 having an inverted triangular shaped orifice has been found useful to provide more even coverage of the irrigation, with parts of a lawn more distant from a sprinkler getting similar irrigation levels with parts of the lawn that are closer to the sprinkler.

As shown, the isosceles triangle has straight sides. However, it will be appreciated that in other embodiments, the edges may barrel outwards in a convex manner, or curve inwards in a concave manner.

With reference to FIGS. 11 and 12, each nozzle 152A, 152B, 152n . . . is provided with a dedicated regulator, which in the embodiments shown in FIGS. 11 and 12, is an external sliding stopper 154A, 154B which serves as a simple valve. Each external sliding stopper 154n may be slid up and down, and positioned to fully close the orifice 152n therebeneath, to partially close it, or to leave it open, allowing unrestricted water flow therethrough.

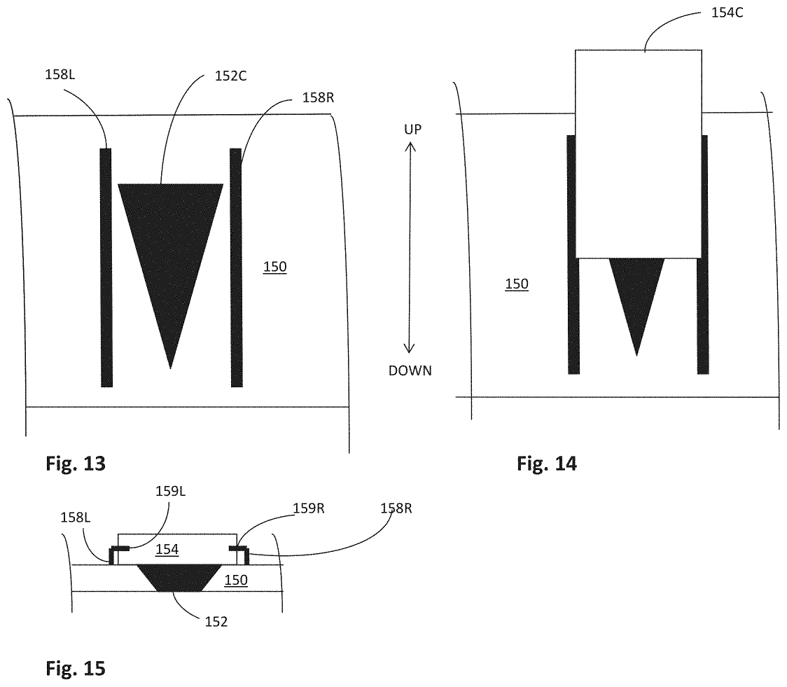

With reference to FIG. 13, where the external sliding valve 154 is removed for clarity, a nozzle having a single triangular orifice 152C is shown through a section of the perimeter wall 150 of a sprinkler head, which may be cylindrical, or may be polygonal, where the number of sides are the same as the number of nozzles, so each side has a nozzle for sprinkling in the direction faced.

A pair of vertical tracks 158L, 158R is provided on each side (Left and Right) of the orifice of the nozzle 152C.

Referring to FIG. 14, a sliding stopper 154C is provided, that slides up and down these tracks, and may be positioned to leave the orifice of the nozzle 152C fully open, to fully close the orifice of the nozzle 152C, to leave it fully closed, or, as shown in FIG. 14, may partially close the nozzle 152C, shrinking the effective size of the nozzle and allowing water to be sprinkled over only a short range.

Referring to FIG. 15, in one embodiment, the tracks 158L, 158R may be provided with tangential extensions that engage a slot along the edges of the sliding stopper 154C, keeping the sliding stopper 154C tightly pressed against the wall 150 of the sprinkler head 110.

The sprinkler head 110 is typically a polymer cap, such as ABS or polypropylene. The sliding stopper 154 of this simple regulator may be fabricated from the same polymer or may be fabricated from or coated with a layer of styrene butadiene rubber (SBR) or other resilient material so as to tightly engage the sides of the track, over the orifice of the nozzle 152C to close the orifice.

In the embodiments of FIGS. 9-15 each nozzle 152n is a single orifice that is elongated in a vertical direction. Each regulator is a sliding stopper 154n that can slide up and down in front of each nozzle 152n. Each sliding stopper 154n may be fully depressed to fully close the nozzle 152n thereunder, preventing water flow through the nozzle 152n, or can be fully raised to expose the entire nozzle 152n, allowing water to flow therethrough and to irrigate surrounding ground in the radial direction faced by the nozzle 152n to a maximum distance from the sprinkler head 110. The sliding stopper 154n can also be positioned to partially cover and partially expose the nozzle 152n thereunder, enabling irrigation to an intermediate distance.

As shown in FIG. 15, the sliding stopper 154 type regulator is retained by the flanges 159L, 159R of the tracks 158L, 158R, and is held tightly against the surface of the perimeter wall 150 of the sprinkler head 110 in front of the nozzle 152, but can slide upwards and downwards along the tracks 158L, 158R to fully expose, partially expose or fully cover the nozzle aperture 152, respectively allowing water to be sprayed through the aperture 152 to the maximum range, to a partial range, or not at all. However, it will be appreciated that within the scope of the invention, there are very many embodiments, and the size and shape of each nozzle, or the number of stacked nozzle in a nozzle stack facing a single radial direction may vary widely. Similarly, there are different regulators that may be used to selectively fully or partially block the orifices of the nozzles of a nozzle array facing a single direction, to close them completely or partially, and the sliding stopper 154 is just one type of valve for a nozzle array.

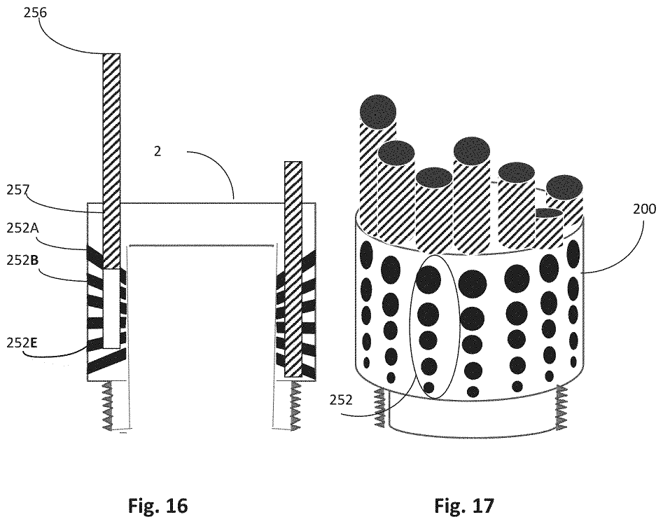

An alternative sprinkler head embodiment 200 is schematically shown in FIGS. 16 and 17, in cross-section and isometric perspectives respectively wherein each spray direction is provided with a nozzle array consisting of a vertical stack of nozzles 252, where each nozzle in the stack has an orifice 252A, 252B . . . 252E of different diameter such that the orifice 252A of the upper nozzle has a larger diameter and the orifice 242E of the lower nozzle has a smaller diameter. As shown in FIG. 16, in certain embodiments the orifices 252A, 252B, . . . 252E of the nozzles in each stack 252 are each provided by nozzles drilled through the wall of the sprinkler head. and the nozzles may be angled to the horizontal to direct the water spray through the larger and higher orifices 252A, 252B to greater distances from the sprinkler head and the lower nozzles have smaller orifices 252E and are directed to the ground nearer to the sprinkler head. In this manner, the irrigation density in volume per unit area irrigated, remains more or less constant over the entire range of the sprinkler.

As in the embodiments of FIGS. 9 to 15, the flow through the nozzles, i.e. each of the orifices 252A, 252B, . . . 252E may be regulated by a regulator of the sliding stopper 154 that slides along a track in front of the orifices to fully or partially close some or all of the orifices. However, as shown in FIGS. 16 and 17, the regulator for each stack of nozzles 252 may alternatively be a valve rod 256 that may be positioned at different depths in a socket 257 behind the orifices 252A, 252B . . . 252E of to block selectively block the nozzles of the stack 252.

Thus in the embodiments of FIGS. 16 and 17, each regulator consists of a vertical socket hole 257 drilled behind each set of orifices 252A, 252B . . . 252E and a valve rod 256 that is provided for selectively plugging the socket hole 257 to different depths. The valve rod 256 may be a close-fitting bung that slides up and down the socket hole 257, or the socket hole 257 and the valve rod 256 may be threaded, so that the position of the valve rod 256 can be accurately set using a screw-driver, and is less likely to vary over time. So long as the diameter of the socket 257 and valve rod 256 is larger than the diameter of the nozzles leading to the orifices 252A, 252B . . . 252E, the valve rod 256 can be set to block the nozzles behind some or all of the orifices 252A, 252B . . . 252E and to thereby prevent water reaching the orifices 252A, 252B . . . 252E.

It will be appreciated that in an alternative way of ensuring more or less constant irrigation with distance, instead of or in addition to varying the diameter of the orifices per horizontal row of an array consisting of a vertical stack of nozzles 252, the number of orifices per row may be varied to create an inverted triangular array of orifices in each radial spray direction. Also, the orifices need not be circular, and could have other shapes.

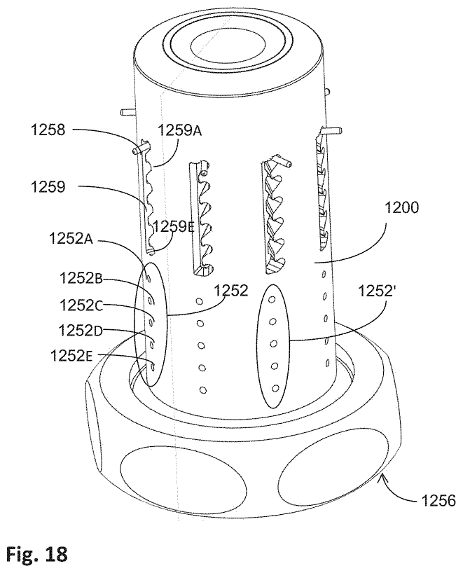

Having explained the principle of this embodiment with reference to FIGS. 16 and 17, a practical embodiment is now described with reference to FIG. 18. Thus in the embodiment of FIG. 18, a sprinkler head 1200 is provided, having a female screw connector 1256 on the inside of the base for attaching to the stem of a sprinkler, such as a pop up sprinkler.

Each radial direction is provided with a stack 1252, 1252′ of nozzles, each ending in an orifice, so stack 1252 is provided with a stack of orifices 1252A, 1252B . . . 1252E. As shown, the orifices 1252A, 1252B . . . 1252E in stack 1252 may each have the same diameter and flow-rate, or, as with the orifices of FIG. 17, the upper ones could have larger diameters, different shapes, or two or more orifices could be positioned adjacently at the same elevation and the walls of the nozzles therebehind may also possibly be angled. Again, a socket may run downwards through the wall of the sprinkler head traversing each nozzle behind each orifice and a rod or a sliding stopper of a different shape is provided within the socket that can be positioned at different heights within the socket to act as a regulator by blocking off one or more nozzles preventing water reaching the orifices, starting with the upper orifice 1252A which generally irrigates at the greatest range. Thus as the rod is lowered within the socket, the orifices 1252A, 1252B, 1252C . . . are blocked one by one, and the range of the sprinkler 1200 in the direction faced by the stack 1252 is shortened to irrigate over a shorter distance.

In this variant embodiment, a peg 1258 is provided that protrudes tangentially from the rod or stopper, and the peg can be slid up and down a slot 1259 in the wall of the sprinkler head 1200 to raise and lower the rod within the socket, thereby opening and closing the orifices 1252A-E. The slot 1259 may be provided with notches along one side. If the rod is lowered slightly by moving the peg 1258 down into notch 1259A, orifice 1252A is blocked and notch 1259A restrains the peg 1258 and stops the water pressure pushing the rod upwards.

If the peg 1258 is pushed all the way down the slot 1259 and positioned in notch 1259E, all the nozzles of the stack are blocked, preventing water flowing through any of the orifices 1252A-E, and no water is sprinkled in the direction opposite the stack 1252.

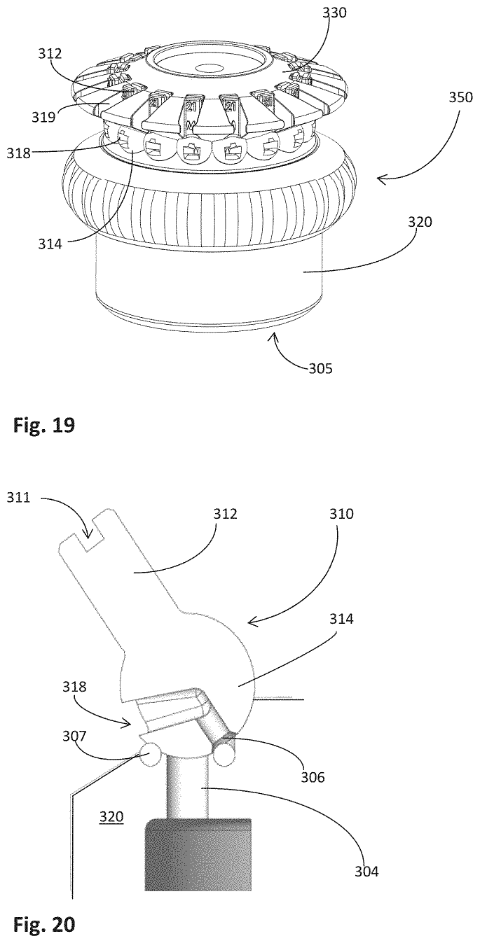

With reference to FIG. 19, a sprinkler head 350 in accordance with a further embodiment is shown in isometric projection. In this embodiment, flow to each nozzle 318 is provided by a ball in socket regulator 310, an embodiment of which is shown in more detail in FIG. 20.

The balls 314 of the ball in socket regulators 310 are held, in certain embodiments, between a base section 320 and a lid 330, and each ball in socket regulator 310 consists of a lever 312 coupled to a ball 314. The lever 312 may be slid back and forth in a slot 319 to rotate the ball 314 and adjust both the flow rate and the elevation of the nozzle 318.

The sprinkler head 350 is attached to the stem of a sprinkler, such as a pop up sprinkler and may be provided with a male or female screw-thread for attaching to the stem of the sprinkler, and either sold with the entire sprinkler unit or retrofitted instead of prior art sprinkler heads to convert an existing system.

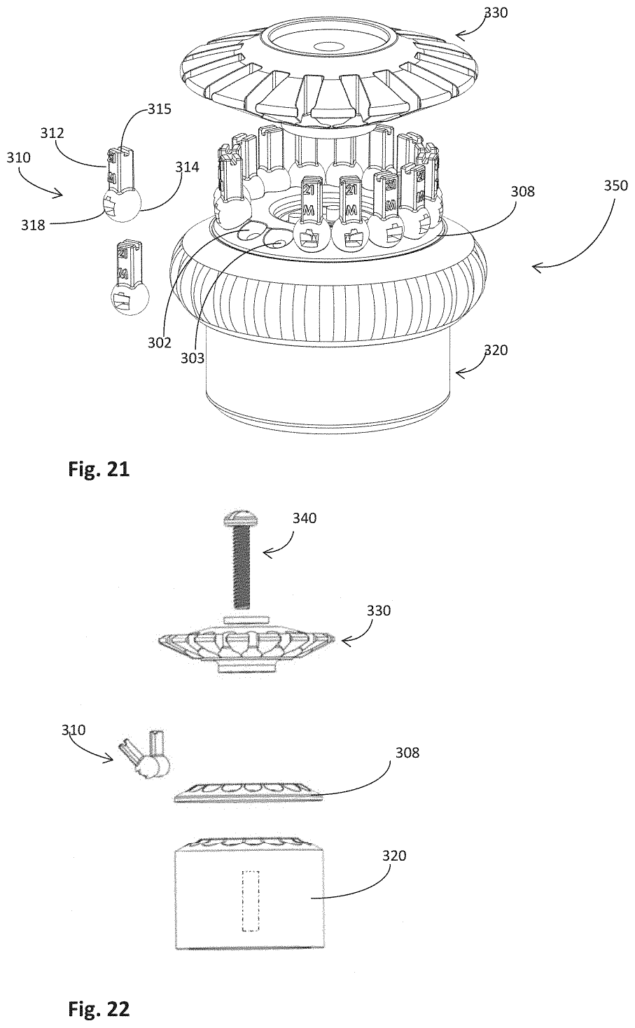

FIGS. 21 and 22 show the sprinkler head of FIG. 19 in blown open view, with the ball in socket regulators 310 configured slightly differently to the configuration of FIG. 20, and, showing how the sprinkler head is assembled.

With reference to FIG. 20, a ball regulator 310 consisting of a ball 314 having a lever 312 extended therefrom for manipulating the orientation of the ball 314 with respect to a conduit 304 that runs through the base 320 of the sprinkler head (FIG. 19 part 350) is shown. A water tight seal is provided between the ball 314 of the regulator 310 and the base 320 to prevent leakage around the ball 314. In FIG. 20, the water tight seal is an O ring.

If the lever 312 is moved in a clockwise direction from the perspective shown in FIG. 20, an inlet 306 is brought into partial and then full alignment with the conduit 304 that runs through the base 320 of the sprinkler head. Water can then flow through the conduit 304, through the inlet 306 and into the ball regulator 310, and out through the orifice at the end of the nozzle 318.

Referring back to FIG. 19, each ball 314 may be rotated by moving its lever 312 within its slot 319 to adjust the tilt of the nozzle 318 from perhaps 20° below the horizontal to perhaps 60° above the horizontal.

As shown, the width of inlet 306 is smaller than the width of conduit 304. This enables the direction of the nozzle 318 to be varied in a vertical arc whilst maintaining constant flow. Although, both inlet 306 and conduit 304 may be circular, in some embodiments, one or other may have different geometries and their relative dimensions may be different as well, giving greater design flexibility. The important thing is that they can be partially aligned, fully aligned or misaligned by rotating the ball 314, providing maximum, partial and no flow through the inlet 306, and thus through the nozzle 318. In certain embodiments, the elevation of the nozzle 318 and the position of the inlet 306 are designed together to provide the desired flow irrigation density over all ranges.

Where the width of the conduit 304 is larger than that of the inlet 306 of the regulator 310 such as drawn in FIG. 20, the elevation of the nozzle 318 may be varied somewhat, varying the range of sprinkling, without reducing the amount of water being sprayed through the nozzle 318. In general, the inlet 306 and conduit 304 size and shape can be configured such that the angle of elevation of the nozzle 318 may be varied independently of varying the flow, or the regulator 310 may be designed to vary the angle of elevation of the nozzle 318 together with the flow rate.

Furthermore, a screw notch 311 may be provided in the end of the lever 312, enabling the regulator 310 to be rotated with respect to the base for adjusting the position and orientation of both the inlet 306 to the ball 314 and the nozzle 318 with respect to the direction of the slot 319.

Referring back to FIG. 19, the lever 312 is generally configured to be slid up and down a slot 319 in the lid 330 of the sprinkler head 350. By depressing the lever 312 within the slot 319, the nozzle 318 may be tilted downwards, decreasing the range of the nozzle 318. If part of the orifice of the nozzle 318 becomes blocked by its surroundings or the inlet 306 to the ball 314 becomes only partially aligned with the conduit 304, the amount of water sprayed through the regulator 310 may be decreased, and if the inlet 306 is fully disconnected from the conduit 304 and a sealing ring 307 provides a tight seal between the ball 314 of the regulator 310 and the base 320, sealing the conduit 304, no water will flow through the regulator 310.

With reference to FIGS. 20 and 21, instead of a separate o-ring 307 per regulator 310 for sealing between each regulator ball 314 and the base 320, a flexible gasket 308 may be provided between the base of the sprinkler head 320 and all the balls 314 of all the regulators 310. The gasket 308 may be provided with molded sockets 302, each with an aperture 303 therein, so that the only when the inlet 306 to the ball 314 of a specific regulator 310 is aligned with the aperture 303 of a socket 302 on the gasket 308, does water flow through the regulator 310.

Thus with reference to FIGS. 20 and 21, in certain embodiments the sprinkler head 350 comprises a plurality of socket seats 302 arranged, typically equidistantly around a gasket 308 that is supported by the body 320 of the sprinkler head. In certain embodiments, within each socket seat 302, an aperture 303 is provided that couples the conduit 304 within the sprinkler head 320 and the ball 314 of the ball regulator 310, for allowing water to flow to the nozzle 318 via the inlet 306 of the ball regulator 310 when the inlet 306 overlaps the aperture 303 allowing fluid contact with the conduit 304 thereunder.

In certain embodiments, each ball 314 of each ball and socket regulator 310 sits in a socket 302 and is held in position between the gasket 308 of sockets 302 and the lid 330 with slots 319 therethrough, by a screw 340 that passes through the lid 330 and gasket 308 and which engages the base 320 and in some embodiments regulates the water pressure and flow into the base 320 and thus the maximum range of the sprinkler head 350. To prevent the levers 312 being inadvertently moved, a cap (not shown) may be over the lid 330 to cover the levers 312.

Once again, the sprinkler head 350 may be provided with a screw thread 305 for attachment to the stem of a sprinkler unit, which may be a female inner thread, for attachment to a corresponding male thread on the stem of the sprinkler, typically a riser of a pop up sprinkler, or could be a male thread for screwing into a riser having a female thread.

Other variations are possible. For example, in an alternative embodiment (not shown), the balls 314 of the ball regulators may be positioned within the base 320, and held against an upper gasket for sealing purposes, where apertures are provided around the base, opposite the nozzles of the regulators, allowing water flow therethrough, and further apertures are provided for the levers.

Generally, with the lever 312 in the upward position, the inlet 306 is fully aligned with the conduit 304 and the nozzle 318 is fully open, and the pipe is directed at an upwards angle to direct water from the orifice 318 of the regulator ball 314 in the trajectory providing the maximum range.

As the lever 312 is depressed, the ball 314 of the ball and socket regulator 310 is rotated such that the nozzle 318 is directed to a lower trajectory for irrigating ground that is closer to the sprinkler, at less than the maximum range.

In general, whilst providing water to the inlet 306 at the base of the ball 314 of the ball and socket regulator 310, the vertical trajectory of the nozzle 318 may be varied over a wide range, such as from a maximum of 60° above the horizontal, to a minimum of perhaps 15° below the horizontal, for example.

Eventually, the ball 314 may be rotated with respect to the conduit 304 sufficiently to partially close the ball regulator 310 by misaligning the inlet 306 from the conduit 304, reducing the water flow therethrough, and if rotated by depressing the lever 312 to a sufficiently low angle, fully closes the water flow to nozzle 318 by the inlet 306 becoming completely detached from the conduit 304 with the O ring 306 preventing leakage from the conduit 304 to the inlet 306.

Usefully, the end of the lever 312 may be provided with a slot 311 for a screw driver, enabling the ball 314 of the regulator 310 to be rotated sideways or tilted to steer irrigation water sprinkled therethrough away from pathways and onto the lawn, for example.

In the embodiment shown, each ball regulator 310 has a single nozzle 318 with a single orifice, however this general ball and socket regulator embodiment is capable of various adaptations. For example, the number of regulators and the type of nozzle can vary. The nozzle may be provided with more than one orifice on the surface of the ball, or two or more nozzles could be provided within the same ball regulator. In some embodiments, a deflector may be provided that extends from the ball 314 above the orifice. In some embodiments, the nozzle 318 may generally end in an orifice having a reversed triangle shape, or in an array of orifices that together provide a generally triangular shape.

It will be noted, that in some embodiments a deflector may be provided that protrudes from the ball above the nozzle, and the position of the inlet 306 and nozzle 318 may be moved by swiveling the deflector about the ball 314, and so the deflector serves as the lever and there is no need for a separate external lever 312.

By virtue of being able to control the flow of water in each direction, embodiments of the invention enable irrigation of the ground around a sprinkler having a sprinkler head of the invention to different distances in each direction, and the spray pattern of the sprinkler head can be better tailored to lawns of irregular shapes.

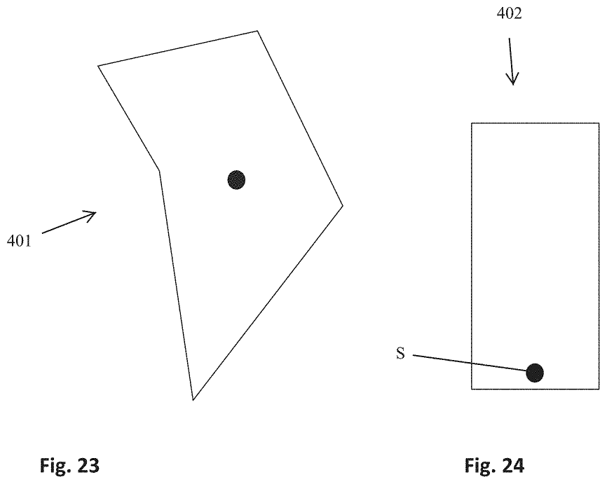

Thus an irregularly shaped lawn, such as 401 shown in FIG. 23 can be effectively irrigated by a single sprinkler having an appropriate maximum range. Furthermore, as shown in FIG. 24, a single sprinkler S may be configured to irrigated a rectangular area 402 without wastage by irrigating surrounding areas.

Persons skilled in the art will appreciate that the invention is not limited to what has been particularly shown and described hereinabove. Rather the scope of the invention is defined by the appended claims and includes both combinations and sub combinations of the various features described hereinabove as well as variations and modifications thereof, which would occur to persons skilled in the art upon reading the foregoing description.

In the claims, the word “comprise”, and variations thereof such as “comprises”, “comprising” and the like indicate that the components listed are included, but not generally to the exclusion of other components.

What is claimed is:

1. A sprinkler head for attaching to a stem of a sprinkler, the sprinkler head having a round or polygonal shaped perimeter and comprising a directional nozzle array on the perimeter of the sprinkler head, the directional nozzle array comprises a single nozzle or a stack of nozzles, each nozzle having an orifice facing a specific radial direction; the directional nozzle array being in fluid connection with a conduit through the stem for providing irrigation in the radial direction;
wherein the directional nozzle array is provided with a dedicated regulator independently configurable by a user for regulating water flow in the specific radial direction over a range from zero when fully closed to a maximum range when fully open.

2. The sprinkler head of claim 1, comprising a plurality of nozzle arrays along a section of the perimeter of the sprinkler head, each nozzle array facing a different radial direction and having a dedicated regulator.

3. The sprinkler head of claim 1, comprising a plurality of nozzle arrays around an entire perimeter of the sprinkler head, each nozzle array having a dedicated regulator and facing in a different radial direction for providing 360° coverage.

4. The sprinkler head of claim 1 wherein the regulator of each nozzle array simultaneously adjusts both an angle of elevation of the nozzle array and the throughput thereof.

5. The sprinkler head of claim 1, wherein each nozzle passes through a wall of the sprinkler head and ends at an orifice on the outer perimeter.

6. The sprinkler head of claim 1, wherein said nozzle array comprises a stack of nozzles facing the same general radial direction and each nozzle of the stack is configured to sprinkle water over an area at a desired distance from the sprinkler head.

7. The sprinkler head of claim 1 wherein each radial direction is provided with a single nozzle having an inverted triangular orifice with a wide top, narrowing downwards to a tip, and the regulator is a sliding valve comprising a stopper that is positionable along a track to block at least part of the orifice, by being slid downwards to progressively block the orifice thereby shrinking the effective size of the orifice and simultaneously reducing both the flow and the range thereof,

8. The sprinkler head of claim 7 wherein side walls of the triangle are selected from the group comprising straight lines, convex curves and concave curves.

9. The sprinkler head of claim 7 wherein the nozzle crosses a wall of the sprinkler head and ends in an orifice on the surface of the sprinkler head, and the regulator comprises a sliding valve.

10. The sprinkler head of claim 7 wherein the sliding valve comprises either a stopper sliding on a track in front of the orifice to block the orifice or a slider configured to slide down a vertical socket crossing the nozzle to block the nozzle.

11. The sprinkler head of claim 1 wherein the nozzle array in the radial direction comprises a stack of nozzles through a wall of the sprinkler head and a single regulator regulates the flow through each nozzle of the stack.

12. The sprinkler head of claim 11 wherein the regulator is a sliding valve comprising either a stopper sliding on a track in front of the stack of nozzles or a slider configured to slide down a vertical socket within the wall of the sprinkler head that crosses the nozzles of the stack of nozzles, to selectively partially or fully block the nozzles from the top.

13. The sprinkler head of claim 11 wherein the stack of nozzles has a general shape of an inverted triangle.

14. The sprinkler head of claim 1 wherein each nozzle comprises a circular orifice.

15. The sprinkler head of claim 14, wherein each orifice is an end of a nozzle through a wall of the sprinkler head that is angled to the horizontal to direct water sprayed therethrough to a different distance from the sprinkler head.

16. The sprinkler head of claim 1, wherein each nozzle is provided with a regulator comprising a ball that rests in a snug fitting socket, and an adjustment lever coupled to the ball; the ball of the ball and socket valve comprising a passage from an inlet that is partially alignable, fully alignable and misalignable with a conduit in the sprinkler head that is coupled to the water supply, to a nozzle ending at an orifice on the perimeter of the ball facing generally outwards from the perimeter of the sprinkler head, such that the adjustment lever can be moved along the slot, thereby adjusting the ball in socket valve from fully closed to fully opened, for simultaneously adjusting the quantity of water sprayed through the nozzle from zero to a maximum and for adjusting a trajectory of the water sprayed to a maximum range.

17. The sprinkler head of claim 16 wherein the nozzle is configured to provide a near constant irrigation density with distance from the sprinkler head over a range.

18. The sprinkler of claim 17 wherein the position and orientation of the nozzle of the regulator can be adjusted by a screw driver engaging a notch for a screw driver provided at an end of the lever.

19. The sprinkler of claim 16 wherein the angle of elevation of the nozzle and/or sideways tilt are adjustable.

20. The sprinkler head of claim 1 further comprising an attachment component or mechanism for attaching to the stem of a fixed or pop-up sprinkler unit.

21. The sprinkler head of claim 1 selected from a head that is integral to a sprinkler unit and a head that is retrofittable to a stem of a sprinkler unit for converting a sprinkler to a sprinkler unit having variable range in a plurality of directions.
